(19) United States
(12) Patent Application Publication
(10) Pub. No.: US 2006/0185737 A1
(43) Pub. Date: Aug. 24, 2006

(54) Pressure relief valve with debris trap

(76) Inventors: Matthew Williamson, Richmond Hill, CA (US); Paul M. Hodges, Richmond Hill, CA (US)

Correspondence Address: HARNESS, DICKEY & PIERCE, P.L.C., P.O. BOX 828, BLOOMFIELD HILLS, MI, 48303, US

(21) Appl. No.: 11/337,902

(22) Filed: Jan. 23, 2006

Related U.S. Application Data
(60) Provisional application No. 60/646,760, filed on Jan. 24, 2005.

(51) Int. Cl. F16K 15/00

(52) U.S. Cl. 137/538

(57) ABSTRACT

A pressure relief valve for a pump includes a recess in its surface adjacent the high pressure side of the pump. The recess acts as a trap to capture and retain debris particles in the working fluid. By capturing and retaining the debris particles in the recess, jamming of the pressure relief valve in an open position can be avoided. Preferably, the upper edge of the recess includes a chamfered edge which enhances the likelihood of the debris particles entering the recess. Also preferably, the recess can be magnetized, or a magnetic member can be inserted into the recess, to enhance the capture and retention of magnetic debris particles in the recess.

### CROSS-REFERENCE TO RELATED APPLICATIONS

This application claims the benefit of U.S. Provisional Application No. 60/646,760, filed on Jan. 24, 2005. The disclosure of the above application is incorporated herein by reference.

### FIELD OF THE INVENTION

The present invention relates to pressure relief valves for pumps. More specifically, the present invention relates to pressure relief valves for pumps wherein the valve has a trap to retain debris to prevent the debris from jamming the valve.

### BACKGROUND OF THE INVENTION

Many pumps, such as oil pumps in automotive engines, include a pressure relief valve to limit the output of the pump to establish an equilibrium operating pressure for the pump which is intended to be largely independent of changes in the operating speed of the pump.

In many cases, these pressure relief valves are quite simple in design and comprise a bucket-like plunger in a bore within the pump, the bore being in fluid communication with the high pressure side of the pump and in fluid communication with at least one waste passage which is in fluid communication with the low pressure side of the pump, or a low pressure gallery or the like. The plunger is biased to a first end of the bore corresponding to a closed position by a spring and, when the plunger is positioned in this closed position, the waste passage is blocked and the output pressure of the pump is not reduced.

As the output pressure of the pump increases, the pressure of the working fluid on the area at the end of the plunger acts against the bias of the spring and, when the pressure is sufficiently high, the plunger is moved from the closed position, further into the bore, exposing the waste passage and allowing pressurized working fluid from the high pressure side of the pump to enter the waste passage, thus reducing the output pressure produced by the pump. As the output pressure of the pump increases, the plunger is moved further into the bore allowing more working fluid to enter the waste passage and as the output pressure of the pump decreases, the biasing force of the spring moves the plunger towards the closed position, reducing the amount of working fluid which can enter the waste passage.

While such pressure relief valves are quite simple in operation and construction, they do suffer from disadvantages. In particular, debris entrained in the working fluid can jam the plunger by being caught between the corner of the upper surface of the plunger and the corner of the waste passage, preventing it from returning to its closed position as the output pressure of the pump is reduced and this can result in the pump producing an insufficient output pressure and/or volume at lower operating speeds. In particular, the corner of the upper surface of the plunger is typically chamfered to ensure that it can clear the corner radius of the bore when in the closed position. This chamfer tends to increase the likelihood that debris will be caught between the corner of the plunger and the corner of the waste passage.

Prior attempts to solve this problem have included using flow-through plunger designs. In such flow-through designs, the plunger includes an upper annular surface joined to the top of the plunger by two or more struts. In the closed position, the annular upper surface has the necessary chamfered corner to engage the end of the bore and the top of the plunger is above the waste passage. When the plunger is moved from the closed position to a position to reduce the output pressure of the pump, the pressurized working fluid flows down past the annular surface to the top of the plunger and then out between the struts to the waste passage. As the top of the plunger does not engage the end of the bore in the closed position, the top of the plunger can have a sharp corner and it is believed that such sharp corners are less likely to be jammed by debris.

While, in some circumstances, flow-through plungers are somewhat less likely to be jammed by debris than conventional plungers, it has been determined that flow-through plungers can still be jammed by debris. Also, flow-through plungers typically require the overall length of the valve and bore to be greater than non-flow-through designs and it is often not possible to design a pump which can provide the necessary length. Further, flow through plungers are more expensive to manufacture, due to the additional machining steps required for their manufacture. In view of the above, and as flow-through plungers do not significantly reduce the chances of jamming, it is believed that they do not offer a worthwhile solution to this problem.

It is desired to have a simple, inexpensive pressure relief valve in which debris entrained in the working fluid is inhibited from jamming the plunger in the bore.

### SUMMARY OF THE INVENTION

It is an object of the present invention to provide a novel pressure relief valve which obviates or mitigates at least one disadvantage of the prior art.

According to a first aspect of the present invention, there is provided a pressure relief valve for a pump pressurizing a working fluid, the valve comprising: a closed bore having a first end in fluid communication with the high pressure side of the pump and having a waste passage located along the length of the bore, the waste passage in fluid communication with a low pressure area of the pump; a plunger moveable within the bore between a first position, wherein the plunger seals the waste passage, substantially preventing fluid communication between the first end of the bore and the waste passage, and a second position wherein the plunger no longer seals the waste passage and the waste passage is in fluid communication with the first end of the bore, the plunger having a recess formed in its surface adjacent the first end of the bore to catch and retain debris particles within the recess; and a biasing spring acting against the plunger to bias the plunger to the first position.

Preferably, the recess includes a chamfered upper inner edge to enhance capture of debris particles in the recess. Also preferably, the recess is magnetized, or includes a magnetic member, to enhance the retention of magnetic debris particles within the recess.

### BRIEF DESCRIPTION OF THE DRAWINGS

Preferred embodiments of the present invention will now be described, by way of example only, with reference to the attached Figures, wherein:

FIGS. 1a and 1b show a side section through a conventional prior art pressure relief valve in a closed and open position respectively;

FIG. 2 shows a prior art plunger from the pressure relief valve of FIGS. 1a and 1b;

FIGS. 3a and 3b shows a side section through a pressure relief valve, in accordance with the present invention, in a closed and an open position respectively; and

FIG. 4 shows a plunger from the pressure relief valve of FIGS. 3a and 3b.

### DETAILED DESCRIPTION OF THE INVENTION

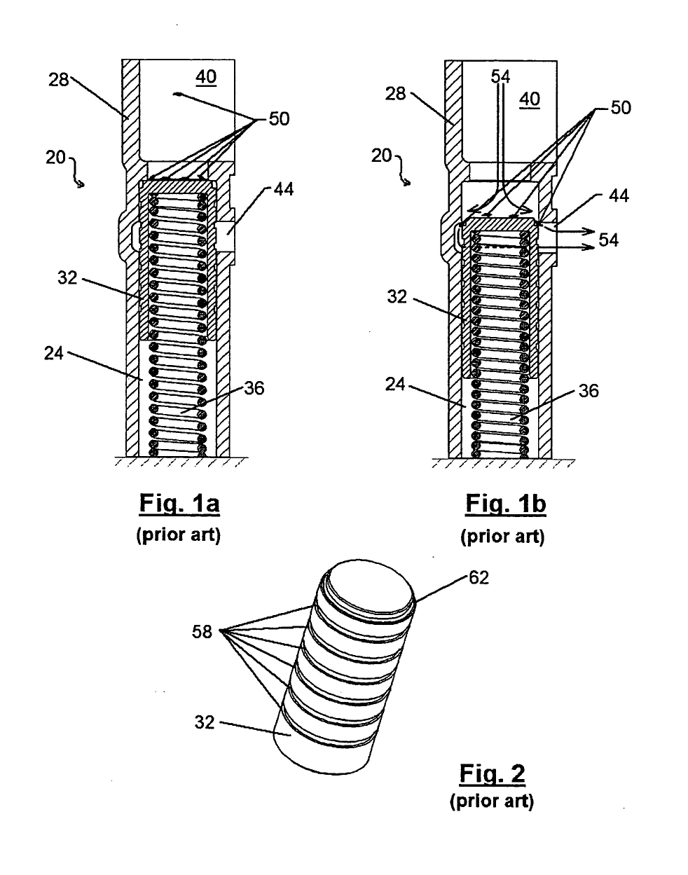

A prior art pressure relief valve is indicated generally at 20 in FIGS. 1a and 1b. As shown, valve 20 comprises a bore 24, typically in the housing 28 of the pump, in which a plunger 32 and a biasing spring 36 are arranged. A plug, such as a bolt or screw (not shown), is located at the end of bore 24 distal plunger 32 to seal bore 24 and biasing spring 36 acts between plunger 32 and this plug or insert. In some other embodiments of valve 20, the plug is located at the other end of bore 24, adjacent a passage that connects that end of bore 24 to the high pressure area of the pump, and biasing spring 36 acts between plunger 32 and the opposite, blind, end of bore 24.

Area 40 in the Figures is in fluid communication with the high pressure side of the pump and waste passage 44 is in fluid communication with a low pressure area, such as the low pressure side of the pump, or a low pressure gallery, etc.

In FIG. 1a, the pressure of the working fluid in area 40 is insufficient to move plunger 32 against the biasing force of spring 36, and plunger 32 is thus in the illustrated closed position wherein fluid communication between area 40 and waste passage 44 is inhibited.

In FIG. 1b, the pressure of the working fluid in area 40 has reached a sufficient level, acting over the top area of plunger 32, to move plunger 32 against the biasing force of spring 36. As illustrated, plunger 32 has been moved down within bore 24 such that a path allowing fluid communication between area 40 and waste passage 44 has been established.

In many environments, such as automotive engines, it is not unusual to have debris particles entrained in the working fluid, such as the lubricating oil. Such particles can be metal filings or the like, resulting from the manufacture and/or assembly of the engine, remaining in the engine, normal wear of engine and/or transmission components, or from debris which has been ingested by the engine and which has reached the lubricating oil, etc.

While engines have working fluid filters to eventually capture and remove such debris, such filters are typically positioned on the high pressure side of the pump and do not prevent debris from moving from the low pressure side to the high pressure side through the pump. Further, while such debris particles can jam valve 20 when valve 20 is in virtually any orientation, the probability of jamming is much higher when valve 20 is orientated with the high pressure area of the pump being vertically above plunger 32. In such orientations, debris particles can settle out of the working fluid, under the influence of gravity, when the pump is not operating and collect on top of plunger 32, thus being more likely to jam valve 20 once the pump starts operating.

In FIG. 1a, debris particles 50 have been carried by the working fluid 54 during operation of the pump, or fallen out of the working fluid when the pump and engine is not operating, onto the top of plunger 32. When plunger 32 is moved to the open position illustrated in FIG. 1b by the pressurized working fluid from the pump, the debris particles can be moved by the flow of working fluid from their position on top of plunger 32 into waste passage 44. If plunger 32 has only moved sufficiently to enable a slight flow of working fluid into waste passage 44, as is often the case, debris particles 50 can be trapped between the upper edge of plunger 32 and the edge of the opening of waste passage 44, thus preventing plunger 32 from returning to the closed position of FIG. 1a. As will be apparent, if plunger 32 is prevented from returning to the closed position of FIG. 1a, the pressure of the working fluid output by the pump will be less than the desired equilibrium operating pressure at low pump operating speeds and damage to the engine or other device supplied with working fluid by the pump is likely to occur.

FIG. 2 shows a prior art plunger 32 in more detail. As shown, plunger 32 can include a plurality of annular grooves 58 which are employed to equalize the forces, produced on plunger 32 by working fluid in bore 24, about the lateral surfaces of plunger 32. As is also shown, typically a chamfer 62 is formed about the periphery of the upper surface of plunger 32 to ensure that plunger clears the corner radius at the end of bore 24 adjacent the high pressure side of the pump. As will be apparent, chamfer 62 also increases the probability that one or more debris particles 50 will be trapped between plunger 32 and waste passage 44, jamming plunger 32 and preventing it from returning to the closed position of FIG. 1a.

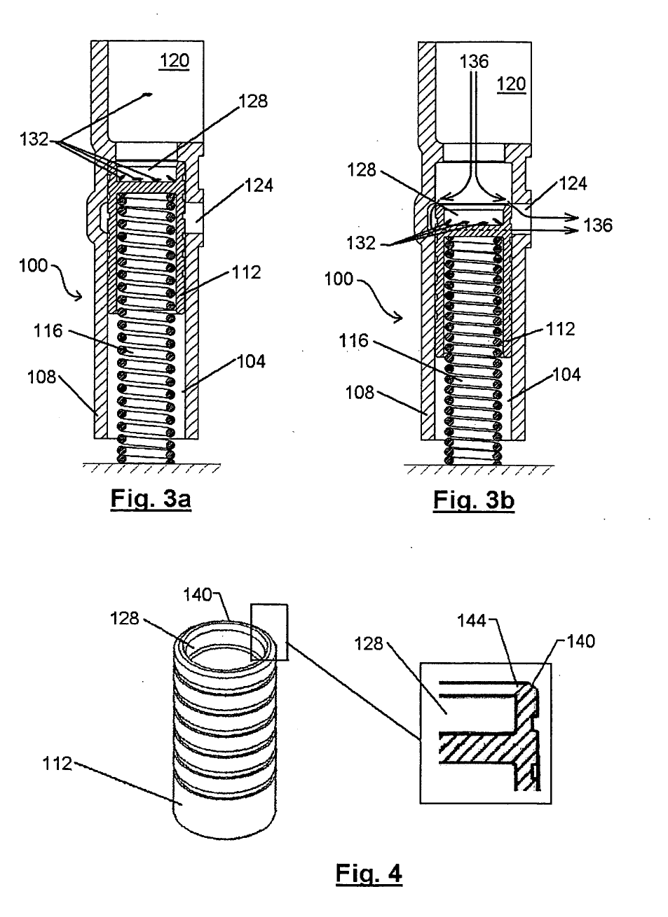

FIGS. 3a and 3b show a pressure relief valve, indicated generally at 100, in accordance with the present invention. Pressure relief valve 100 comprises a bore 104, typically in the housing 108 of the pump, in which a plunger 112 and a biasing spring 116 are arranged. Typically a plug or insert (not shown) is located at the end of bore 104 distal plunger 112 to seal bore 104 and biasing spring 116 acts between plunger 112 and this plug or insert. The present invention is not limited to the plug being located at the end of bore 104 distal the high pressure area of the pump and the plug can be located at the other end of bore 104, adjacent a passage connecting this end of bore 104 with the high pressure area of the pump, with biasing spring 116 acting between plunger 112 and the other end of bore 104, which is a blind end.

Area 120 in FIGS. 3a and 3b is in fluid communication with the high pressure side of the pump and a waste passage 124 is in fluid communication with a low pressure area, such as the low pressure side of the pump, or a low pressure gallery, etc.

In FIG. 3a, the pressure of the working fluid in area 120 is insufficient to move plunger 112 against the biasing force of spring 116, and plunger 112 is thus in the illustrated closed position wherein fluid communication between area 120 and waste passage 124 is inhibited.

In FIG. 3b, the pressure of the working fluid in area 120 has reached a sufficient level, acting over the top area of plunger 112, to move plunger 112 against the biasing force of spring 116. As illustrated, plunger 112 has been moved down within bore 104 such that a path allowing fluid communication between area 120 and waste passage 124 has been established.

Unlike the prior art pressure relief valve 20 illustrated in FIGS. 1a and 1b, in pressure relief valve 100 plunger 112 includes a recess 128 on its upper surface, best seen in FIG. 4, and recess 128 acts as a debris trap to catch debris particles 132 that were entrained in, or carried by, the working fluid of the pump.

Recess 128 is sufficiently deep that debris particles 132 which are captured in it are not drawn out of recess 128 by the passage of the working fluid 136 over the top of plunger 112 and into waste passage 124 in the open position, illustrated in FIG. 3b. Thus, debris particles 132 cannot be caught between waste passage 124 and plunger 112 and plunger 112 cannot be jammed in an open position, unlike prior art pressure relief valve 20.

Plunger 112 is shown in more detail in FIG. 4, wherein recess 128 can be seen. As shown, the upper surface of the outer wall 140 of recess 128 includes a chamfered inner edge 144 to enhance the likelihood that debris particles 132 will enter recess 128 in addition to the conventional outer chamfered edge to clear the corner radius at the end of bore 104 adjacent the high pressure area of the pump.

It is also contemplated that recess 128 can be magnetized, or a magnetic insert placed in the bottom of recess 128, to better retain magnetic debris particles 132 within recess 128.

As will now be apparent, recess 128 acts to trap debris particles 132 within recess 128, thus preventing the jamming of plunger 112 by such debris particles. It is contemplated that pressure relief valve 100 can be fabricated with plunger 112, or plunger 112 can be retrofitted to existing prior art pressure relief valves to obtain pressure relief valve 100 in accordance with the present invention.

The above-described embodiments of the invention are intended to be examples of the present invention and alterations and modifications may be effected thereto, by those of skill in the art, without departing from the scope of the invention which is defined solely by the claims appended hereto.

What is claimed is:

1. A pressure relief valve for a pump pressurizing a working fluid, the valve comprising:
a closed bore having a first end in fluid communication with the high pressure side of the pump and having a waste passage located along the length of the bore, the waste passage in fluid communication with a low pressure area of the pump;
a plunger moveable within the bore between a first position, wherein the plunger seals the waste passage, substantially preventing fluid communication between the first end of the bore and the waste passage, and a second position wherein the plunger no longer seals the waste passage and the waste passage is in fluid communication with the first end of the bore, the plunger having a recess formed in its surface adjacent the first end of the bore to catch and retain debris particles within the recess; and
a biasing spring acting against the plunger to bias the plunger to the first position.

2. The pressure relief valve of claim 1 wherein the recess includes a chamfered inner edge to enhance capture of debris particles in the recess.

3. The pressure relief valve of claim 1 wherein the recess is magnetized to enhance the retention of magnetic debris particles within the recess.

4. The pressure relief valve of claim 1 further including a magnetic member inserted into the bottom of the recess to enhance the retention of magnetic debris particles within the recess.

5. The pressure relief valve of claim 1 wherein the valve is obtained by retrofitting a plunger with the recess to an existing pressure relief valve.
